(19) United States
(12) Patent Application Publication
(10) Pub. No.: US 2026/0243964 A1
(43) Pub. Date: Aug. 20, 2026

(54) MODE GROUP DEMULTIPLEXING METHOD AND DEVICE BASED ON CASCADED DIFFRACTIVE NETWORK

(71) Applicant: SUN YAT-SEN UNIVERSITY, Guangdong (CN)

(72) Inventors: Zhaohui LI, Guangdong (CN); Zhibing LIU, Guangdong (CN)

(73) Assignee: SUN YAT-SEN UNIVERSITY, Guangdong (CN)

(21) Appl. No.: 19/430,319

(22) Filed: Dec. 23, 2025

(30) Foreign Application Priority Data
Feb. 17, 2025 (CN) 202510169326.5

(51) Int. Cl. G02B 6/293

(52) U.S. Cl. CPC G02B 6/2938; G02B 6/29319; G02B 6/29325

(57) ABSTRACT

The present invention relates to the technical field of multiplexing and demultiplexing devices in space-division multiplexing, and in particular to a mode group demultiplexing method and device based on a cascaded diffractive network. In the mode group demultiplexing method, a non-deterministic mode conversion strategy is used to design and optimize the cascaded diffractive network, enhancing a degree of freedom of an output mode field, thereby allowing a phase plate to be designed more flexibly. This can significantly improve beam conversion efficiency and greatly reduce a quantity of required phase plates. The present invention overcomes disadvantages of low energy efficiency and stability in mode group demultiplexing, and reduces device loss by improving and optimizing the design.

### CROSS-REFERENCE TO RELATED APPLICATION

This application claims the priority benefit of China application no. 202510169326.5, filed on Feb. 17, 2025. The entirety of the above mentioned patent applications is hereby incorporated by reference herein and made a part of this specification.

### TECHNICAL FIELD

The present invention relates to the technical field of multiplexing and demultiplexing devices in space-division multiplexing, and in particular to a mode group demultiplexing method and device based on a cascaded diffractive network.

### BACKGROUND

With the rapid development of technologies such as the Internet, Internet of Things, and 5G communications, global demand for data transmission is experiencing explosive growth. As time-division multiplexing, wavelength-division multiplexing, and high order modulation technologies mature, a capacity of a single-mode fiber is gradually approaching a theoretical limit. In an upgrade solution, a spatial dimension of fibers is developed, and the orthogonality of a spatial mode is used to expand the capacity of a single fiber, which is also known as mode-division multiplexing. A drawback of the mode-division multiplexing is significant susceptibility to mode coupling, which necessitates heavy reliance on partial or full multiple-input multiple-output digital signal processing. Therefore, high costs for short-distance optical interconnection in this manner are usually unacceptable. To address this issue, a mode group multiplexing technology based on a weakly coupled fiber has been proposed, enabling intensity modulation and direct detection technologies to be used in short-distance scenarios. Because group delay of a plurality of modes within the same mode group is nearly identical, these modes can be simultaneously detected and regarded as a single spatial channel. In this manner, although a mode degree of freedom is limited to some extent, system complexity can be reduced.

Compared with a mode group multiplexing technology, there is a lack of research on a mode group demultiplexing device. Due to strong coupling among the plurality of modes within the same mode group, mode group multiplexing requires only excitation of one of the modes. In this way, mapping from a plurality of single-mode fibers to a plurality of mode groups can be established. However, a mode group multiplexer cannot be simply reversed for mode group demultiplexing, because a mode group includes a plurality of mutually coupled modes, and conversion into a single-mode fiber inevitably leads to partial mode energy loss.

For mode group demultiplexing, a common approach is to receive one mode within the mode group and concentrate mode group energy into the mode by controlling fiber mode crosstalk. In the another solution, all modes in the mode group are demodulated into a plurality of single-mode fibers, and then these fibers are combined into the same fiber. A disadvantage of the above fiber mode group demultiplexing solution is an incapability of implementing efficient and stable separation of fiber mode groups; and receiving energy of a single mode within the mode group will fluctuate along with a mode coupling condition, resulting in a signal instability at a receiver. A stepwise idea that all modes in the mode group are demodulated and then merged is redundant and prone to additional loss and crosstalk.

### SUMMARY

The present invention is intended to provide a mode group demultiplexing method and device based on a cascaded diffractive network to overcome shortcomings of low energy efficiency and low stability in mode group multiplexing in the prior art, which effectively improves energy efficiency and stability during mode multiplexing.

To solve the above technical problems, technical solutions used by the present invention are as follows.

A mode group demultiplexing method based on a cascaded diffractive network is provided, including the following steps:
S1: initializing a phase plate parameter;
S2: selecting an input mode E_{0,m}: setting mode field distribution of the selected input mode as an input optical field based on an input weakly coupled fiber;
S3: calculating an output mode field of cascaded diffraction: calculating an output mode field E_{N+1,m} of the cascaded diffractive network based on the selected input mode E_{0,m};
S4: calculating a projection of the output mode field E_{N+1,m} onto a basis: projecting the output mode field E_{N+1,m} onto a mode basis of a corresponding channel in an output fiber array;
S5: calculating a mode group transmission matrix T_{i,j}: calculating energy of the output mode field coupled into each channel of the output fiber array, where coupling efficiency is a sum of corresponding mode basis components, and is represented by the transmission matrix T_{i,j}; and T_{i,j} represents a power when transmission is performed by an i-th mode group at an input end and receiving is performed by a j-th mode group channel at an output end;
S6: calculating a scalar evaluation function based on the transmission matrix T_{i,j};
S7: error gradient backpropagation: determining a gradient of a phase plate thickness Hₖ based on an error backpropagation method;
S8: gradient descent parameter correction: further iteratively updating a new set of phase plate parameters based on gradient information in step S7 and in combination with a gradient descent method; and
S9: calculating average loss and average crosstalk of a mode group demultiplexing device; and
S10: determining whether the loss and crosstalk meet a standard; and if yes, outputting phase plate distribution; if not, returning to step S2.

In the mode group demultiplexing method based on the cascaded diffractive network which is provided by the present invention, a non-deterministic mode conversion strategy is used to design and optimize the cascaded diffractive network, enhancing a degree of freedom of an output mode field, thereby allowing a phase plate to be designed more flexibly. This can significantly improve beam conversion efficiency and greatly reduce a quantity of required phase plates. The present invention overcomes disadvantages of low energy efficiency and stability in mode group demultiplexing, and reduces device loss by improving and optimizing the design.

Preferably, in step S3, the output mode field E_{N+1,m} of the cascaded diffractive network is calculated by the following formula:

$${E}_{N + 1 , m} = {E}_{0 , m} {F}_{1} {M}_{1} {F}_{2} {M}_{2} … {F}_{N} {M}_{N} {F}_{N + 1}$$

where N represents a quantity of phase plates; E_{0,m} represents an m-th input mode of the input weakly coupled fiber; E_{N+1,m} represents a corresponding final output mode field; Mk represents modulation of the optical field by a k-th phase plate Pₖ and is a diagonal matrix with exp(jPₖ) as diagonal elements; and Fₖ represents a transmission matrix corresponding to k-th diffraction, where k=1,2,3, . . . , N, and m is a positive integer.

Preferably, in step S4, the projection of the output mode field E_{N+1,m} onto the basis is calculated by the following formula:

$${c}_{m , n , r} = 〈 {E}_{N + 1 , m} {B}_{n , r} 〉 , r \leq S$$

where c_{m,n,r} represents a projection coefficient, B_{n,r} represents an r-th mode basis of an n-th receiving channel in the output fiber array; and S represents a quantity of mode bases supported by each fiber in the fiber array, and r is a positive integer.

Preferably, in step S5, the transmission matrix T_{i,j} is calculated by the following formula:

$${T}_{i , j} = {\sum }_{all m ∈ {MG}_{i}} {\sum }_{r = 1}^{S} {\vert {c}_{m , j , r} \vert}^{2} ) / \vert {MG}_{i} \vert$$

where MGᵢ represents a set of all modes in an i-th mode group of the input weakly coupled fiber, and |MGᵢ| is a quantity of modes included in the i-th mode group of the input weakly coupled fiber.

Preferably, in step S6, based on the transmission matrix T, the scalar evaluation function L is defined to inversely optimize each phase plate Pₖ in the cascaded diffractive network, with the scalar evaluation function L expressed as follows:

$$L = 1 - a min \{ {T}_{i , i} \vert 1 \leq i \leq Q \} + b max \{ {T}_{i , j} \vert i \neq j , 1 \leq j , i \leq Q \}$$

where L reflects the loss and crosstalk, a and b are used to control weight of the loss and crosstalk respectively; Q represents a quantity of channels in the fiber array; and L is determined by phase distribution of the phase plates and is a multivariate function with a phase plate parameter Pₖ as a variable.

Preferably, in step S7, for ease of practical fabrication, a phase of the phase plate is replaced by distribution of an actual thickness Hₖ. A reflective phase plate is used as an example, a relationship between the phase plate thickness Hₖ and the phase plate Pₖ satisfies Pₖ=4π Hₖ/λ, where λ is an operating wavelength. Based on an error backpropagation method, a gradient of the phase plate thickness Hₖ is expressed as follows:

$$\frac{\partial L}{\partial {H}_{k}} = \frac{- λ}{2 π} Im \{ {Σ}_{m = 1}^{Q} diag [ {( {E}_{0 , m} {F}_{1} {M}_{1} … {F}_{k} {M}_{k} )}^{T} ( \frac{\partial L}{\partial {E}_{N + 1 , m}} {{F}_{N + 1}}^{T} {M}_{N} … {{F}_{k + 1}}^{T} ) ] \}$$

where Im represents getting an imaginary part of an operation result, and diag represents getting a diagonal element of the matrix.

Preferably, in step S8, the phase plate parameter is updated by the following formula:

$${H}_{k} \to {H}_{k} - α \partial L / \partial {H}_{k}$$

where α represents a learning rate and used to control a magnitude of parameter update. α can be set as a fixed value or adaptively determined by a specific algorithm during parameter iterative optimization.

Preferably, in step S9, average loss ILₐᵥₑ and average crosstalk XTₐᵥₑ are calculated by the following formula:

$${IL}_{a v e} = 10 {log}_{10} ( \frac{1}{Q} {Σ}_{n = 1}^{Q} {T}_{n n} ) , X {T}_{a v e} = 10 {log}_{10} ( \frac{1}{Q} {Σ}_{n = 1}^{Q} \frac{1}{Q - 1} {Σ}_{m \neq n}^{Q} {T}_{m n} / {T}_{n n} ) .$$

The above parameter update process can be terminated once designed loss and crosstalk meet a predetermined standard, and corresponding phase plate distribution is output.

Preferably, the phase plate can be further fabricated as an actual diffractive optical element by grayscale exposure or binary photolithography, and plated with an enhanced reflection film by evaporation.

Preferably, the phase plate is processed by binary, where the phase plate distribution is first discretized into 2^{V} steps, and then binarized as follows:

$${[ {b}_{V} … {b}_{1} {b}_{0} ]}_{binary} = floor ( \frac{2 H}{λ} \times {2}^{V} )$$

where b₀, b₁, . . . , b_{V} are V binary lithography masks, and etch depths corresponding to each the binary lithography masks are λ/2^{V+1}, λ/2^{V}, λ/2² respectively, to implement 2π phase modulation at wavelength λ.

The present invention further provides a mode group demultiplexing device based on a cascaded diffractive network, including an input weakly coupled fiber, a cascaded diffractive network, and an output fiber array, where the input weakly coupled fiber includes Q mode groups to be demultiplexed, and each mode group includes several modes; the output fiber array includes Q channels, and each fiber in the output fiber array supports S mode bases, with a quantity of the mode bases not less than a quantity of modes in a mode group of the input weakly coupled fiber; the cascaded diffractive network includes several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffraction layer in any one of corresponding mode bases or any linear superposition of mode bases, and a target output of the cascaded diffractive network is any linear superposition of S mode bases, where the cascaded diffractive network is optimally designed using the above mode group demultiplexing method based on the cascaded diffractive network.

Preferably, the input weakly coupled fiber includes a few-mode fiber or a multi-mode fiber, and includes Q mode groups to be demultiplexed, each mode group includes several modes, and these modes include but are not limited to an orbital angular momentum mode, a linear polarization mode, a Laguerre-Gaussian mode, and a Hermite-Gaussian mode.

Preferably, the output fiber array includes Q channels, corresponding to the Q mode groups to be demultiplexed in the input weakly coupled fiber. The output fiber array is a few-mode fiber array or a multi-mode fiber array, each fiber supports S mode bases, and a plurality of fibers can be consistent and satisfy that a quantity of mode bases S is not less than a quantity of modes in a mode group of the input weakly coupled fiber. Each channel of the output fiber array can receive an output of the cascaded diffractive network in any one of corresponding mode bases or any linear superposition of corresponding modes.

Preferably, the cascaded diffractive network includes several spatially separated phase plates, and the several spatially separated phase plates can be transmissive or reflective, with working space located between the input weakly coupled fiber and the output fiber array. A function of the several phase plates is to implement spatial separation of mode groups in the input weakly coupled fiber, ensuring that mode group energy can be maximally coupled to a corresponding channel of the output fiber array. The target output of the cascaded diffractive network is not a deterministic mode, but any linear superposition of the mode bases of the corresponding channels of the output fiber array.

Preferably, the input weakly coupled fiber, the cascaded diffractive network, and the output fiber array can be fixed onto the same substrate using UV adhesive after preparation, to form a stably packaged mode group demultiplexing device.

Compared with the prior art, the present invention has the following beneficial effects.

In the mode group demultiplexing method and device based on the cascaded diffractive network provided by the present invention, a non-deterministic mode conversion strategy is used to design and optimize the cascaded diffractive network, enhancing a degree of freedom of the output mode field, thereby allowing the phase plates to be designed more flexibly. This significantly improves beam conversion efficiency and greatly reduces a quantity of required phase plates. The present invention overcomes disadvantages of low energy efficiency and stability in mode group demultiplexing, and reduces device loss by improving and optimizing the design.

### BRIEF DESCRIPTION OF DRAWINGS

FIG. 1 is a schematic flow diagram of a mode group demultiplexing method based on a cascaded diffractive network;

FIG. 2 is a schematic diagram of a frame structure of a mode group demultiplexing device based on a cascaded diffractive network;

FIG. 3 is a schematic diagram of phase pattern design for a group of phases used for orbital angular momentum mode multiplexing in Embodiment 3;

FIG. 4 is a schematic diagram of intensity distribution of each mode in a few-mode fiber in Embodiment 3; and

FIG. 5 is an output mode field result corresponding to an orbital angular momentum mode after passing through a cascaded diffractive network in Embodiment 3.

In the drawings: 1, input weakly coupled fiber; 2, cascaded diffractive network; 3, fiber array.

### DETAILED DESCRIPTION OF EMBODIMENTS

The following provides a further description of the present invention with reference to specific implementations. Drawings are provided for exemplary illustration only and represent only schematic diagrams rather than actual objects, and should not be construed as limiting the present invention. For better description of embodiments of the present invention, some components in the drawings may be omitted, enlarged, or reduced, which do not represent actual product dimensions. It can be understood that, for those skilled in the art that some well-known structures and descriptions thereof may be omitted in the drawings.

In the drawings of the embodiments of the present invention, identical or similar reference numerals are corresponding to identical or similar components. In the description of the present invention, it should be understood that terms “upper”, “lower”, “left”, “right” and other indicated directional or positional relationships are based on orientation or positional relationships shown in the drawings, and are only for ease of describing and simplifying the description of the present invention, and do not indicate or imply that indicated devices or elements need to have specific orientations or be constructed or operated in the specific orientations. Therefore, the terms describing the positional relationships in the drawings are for exemplary illustration only and should not be construed as limiting the present invention. For those of ordinary skill in the art, specific meanings of the above terms can be understood according to a specific context.

### Embodiment 1

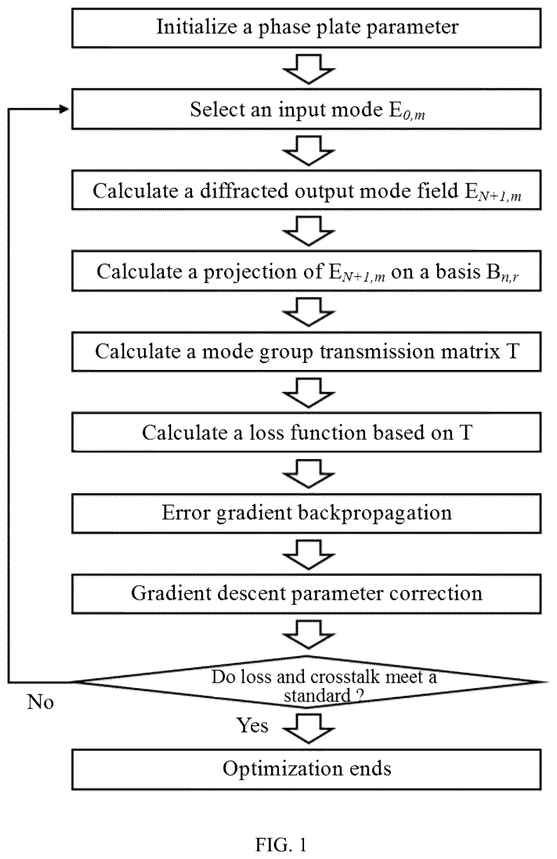

This embodiment is a first embodiment of a mode group demultiplexing method based on a cascaded diffractive network 2, as shown in FIG. 1. The method includes the following steps.

Step 1: First, construct a cascaded diffraction transmission model to optimize a plurality of phase plates of the cascaded diffractive network 2. A mode of an input weakly coupled fiber 1 is given, and according to Rayleigh-Sommerfeld diffraction, an output of the cascaded diffractive network 2 is as follows:

$${E}_{N + 1 , m} = {E}_{0 , m} {F}_{1} {M}_{1} {F}_{2} {M}_{2} … {F}_{N} {M}_{N} {F}_{N + 1}$$

where N represents a quantity of phase plates; E_{0,m} represents an m-th input mode of the input weakly coupled fiber 1; E_{N+1,m} represents a corresponding final output mode field; Mk represents modulation of an optical field by a k-th phase plate Pₖ, k=1, 2, 3, . . . , N, which is a diagonal matrix with exp(jPₖ) as diagonal elements; and Fₖ represents a transmission matrix corresponding to a k-th diffraction, which depends on a starting position of k-th diffraction space.

Step 2: Project the output mode field E_{N+1,m} onto a mode basis of a channel corresponding to a fiber array 3 after obtaining the output of the cascaded diffractive network 2, without comparing to a specific target mode field:

$${c}_{m , n , r} = 〈 {E}_{N + 1 , m} , {B}_{n , r} 〉 , r \leq S$$

where c_{m,n,r} represents a projection coefficient, B_{n,r} represents an r-th mode basis of an n-th receiving channel of the output fiber array 3; and S represents a quantity of mode bases supported by each fiber in the fiber array 3. Receiving fibers for different mode groups are different, and thus, corresponding mode bases are also different.

Step 3. Calculate energy coupled the output mode field coupled to each channel of the output fiber array 3, where coupling efficiency is a sum of corresponding mode basis components and can be described by the following transmission matrix T:

$${T}_{i , j} = {Σ}_{all m ∈ M {G}_{i}} ( {Σ}_{r = 1}^{S} {\vert {c}_{m , j , r} \vert}^{2} ) / \vert {MG}_{i} \vert$$

where MGᵢ represents a set of all modes in an i-th mode group of the input weakly coupled fiber 1, |MGᵢ| is a quantity of modes included in the i-th mode group of an input weakly coupled fiber; and T_{i,j} represents a power when transmission is performed by the i-th mode group at an input end and receiving is performed by a j-th mode group channel at an output end.

Step 4: To inversely optimize a phase Pₖ of each phase plate in the cascaded diffractive network 2, define a scalar evaluation function based on the transmission matrix T as follows:

$$L = 1 - a min \{ {T}_{i , i} \vert 1 \leq i \leq Q \} + b max \{ {T}_{i , j} \vert i \neq j , 1 \leq j , i \leq Q \}$$

where L reflects loss and crosstalk, a and b are used to control weight of the loss and crosstalk respectively; Q represents a quantity of channels in the fiber array 3; and L is determined by phase distribution of the phase plates and is a multivariate function with a phase plate parameter Pₖ as a variable.

Step 5: For ease of practical fabrication, replace a phase of the phase plate by distribution of an actual thickness Hₖ, where a reflective phase plate is used as an example, a relationship between the phase plate thickness Hₖ and the phase plate Pₖ satisfies Pₖ=4π Hₖ/λ, λ is an operating wavelength, and based on an error backpropagation method, a gradient of the phase plate thickness Hₖ is expressed as follows:

$$\frac{\partial L}{\partial {H}_{k}} = \frac{- λ}{2 π} Im \{ {Σ}_{m = 1}^{Q} diag [ {( {E}_{0 , m} {F}_{1} {M}_{1} L {F}_{k} {M}_{k} )}^{T} ( \frac{\partial L}{\partial {E}_{N + 1 , m}} {{F}_{N + 1}}^{T} {M}_{N} L {{F}_{k + 1}}^{T} ) ] \}$$

where Im represents to get an imaginary part of an operation result, and diag represents to get a diagonal element of the matrix.

Step 6: Indicate an optimization direction by the above gradient information, and combined with a gradient descent method, iteratively update a new set of phase plate parameters as follows:

$${H}_{k} \to {H}_{k} - α \partial L / \partial {H}_{k}$$

where α represents a learning rate, used to control a magnitude of parameter update. α can be set as a fixed value or adaptively determined by a specific algorithm during parameter iterative optimization.

Step 7: Calculate average loss ILₐᵥₑ and average crosstalk XTₐᵥₑ of a mode group demultiplexing device as follows:

$${IL}_{a v e} = 10 {log}_{10} ( \frac{1}{Q} {Σ}_{n = 1}^{Q} {T}_{n n} ) , X {T}_{a v e} = 10 {log}_{10} ( \frac{1}{Q} {Σ}_{n = 1}^{Q} \frac{1}{Q - 1} {Σ}_{m \neq n}^{Q} {T}_{m n} / {T}_{n n} )$$

The above parameter update process can be terminated once designed loss and crosstalk meet a predetermined standard, and corresponding phase plate distribution is output.

In this embodiment, phase plate parameters of the cascaded diffractive network 2 can be further processed into an actual diffractive optical element by grayscale exposure or binary lithography, and plated with an enhanced reflection film by evaporation.

In binary processing for the phase plates, the phase plate distribution can be discretized into 2^{V} steps, and then binarized as follows:

$${[ {b}_{V} … {b}_{1} {b}_{0} ]}_{binary} = floor ( \frac{2 H}{λ} \times {2}^{V} )$$

where b₀, b₁, . . . , b_{V} are V binary lithography masks, and etch depths corresponding to each the binary lithography mask are λ/2^{V+1}, λ/2^{V}, λ/2² respectively, to implement 2π phase modulation at wavelength λ.

Although the cascaded diffractive network 2 has previously been proven to be used for multiplexing and demultiplexing various modes, the cascaded diffractive network 2 cannot be directly used for an original solution. A key difference is that mode group demultiplexing needs to demultiplex a plurality of modes within the same mode group to the same spatial location, so that these modes can be received by the same detector. Conventional single-mode fiber cannot simultaneously collect mode fields of a plurality of modes, otherwise energy fluctuations occur. Therefore, multi-mode fiber can be used for reception. In this embodiment, considering the multi-mode degrees of freedom of the multi-mode fiber, a non-deterministic mode conversion strategy is adopted for the design and optimization of the cascaded diffractive network 2. A benefit of this strategy is that this strategy increases a degree of freedom of the output mode field, allowing the phase plate to be designed more flexibly. This can significantly improve the efficiency of beam conversion and greatly reduce a required quantity of phase plates.

### Embodiment 2

This embodiment is an embodiment of a mode group demultiplexing device based on a cascaded diffractive network 2. In this embodiment, the mode group demultiplexing device includes an input weakly coupled fiber, the cascaded diffractive network 2, and an output fiber array 3. The input weakly coupled fiber includes Q mode groups to be demultiplexed, and each mode group includes several modes. The output fiber array 3 includes Q channels, each fiber in the output fiber array 3 supports S mode bases, and a quantity of the mode bases is not less than a quantity of modes in the mode group of the input weakly coupled fiber. The cascaded diffractive network 2 includes several spatially separated phase plates, with working space for the several phase plates located between the input weakly coupled fiber 1 and the output fiber array 3, used to implement spatial separation of mode groups in the input weakly coupled fiber 1, ensuring that mode group energy can be maximally coupled to a corresponding channel of the output fiber array 3. Each channel of the output fiber array 3 can receive an output of a cascaded diffraction layer in any one of corresponding mode bases or any linear superposition thereof, and a target output of the cascaded diffractive network 2 is any linear superposition of S mode bases.

In this embodiment, the input weakly coupled fiber 1, as a light source input, includes a few-mode fiber or a multi-mode fiber, and includes Q mode groups to be demultiplexed, each mode group includes several modes, and these modes include but are not limited to an orbital angular momentum mode, a linear polarization mode, a Laguerre-Gaussian mode, and a Hermite-Gaussian mode.

In this embodiment, the output fiber array 3 includes Q channels, corresponding to the Q mode groups to be demultiplexed in the input weakly coupled fiber 1. The output fiber array 3 is a few-mode fiber array 3 or a multi-mode fiber array 3, each fiber supports S mode bases, and a plurality of fibers can be consistent and satisfy that a quantity of mode bases S is not less than a quantity of modes in a mode group of the input weakly coupled fiber 1. Each channel of the output fiber array 3 can receive an output of the cascaded diffractive network 2 in any one of corresponding mode bases or any linear superposition thereof.

In this embodiment, the cascaded diffractive network 2 includes several spatially separated phase plates, and the several phase plates can be transmissive or reflective, with working space located between the input weakly coupled fiber 1 and the output fiber array 3. A function of the several phase plates is to implement spatial separation of mode groups in the input weakly coupled fiber 1, ensuring that the mode group energy can be maximally coupled to a corresponding channel of the output fiber array 3. The target output of the cascaded diffractive network 2 is not a deterministic mode, but any linear superposition of the mode bases of the corresponding channels of the output fiber array 3.

After the above mode group demultiplexing framework is constructed, further optimization design of the cascaded diffractive network 2 is required to ensure proper conversion from the input weakly coupled fiber 1 to the fiber array 3. An optimization process of the cascaded diffractive network 2 is implemented using the method in Embodiment 1.

In this embodiment, the input weakly coupled fiber 1, the cascaded diffractive network 2, and the output fiber array 3 can be fixed onto the same substrate using UV adhesive after preparation, to form a stably packaged mode group demultiplexing device.

### Embodiment 3

This embodiment provides a specific example of a 6-mode group demultiplexing device based on Embodiment 1 and Embodiment 2.

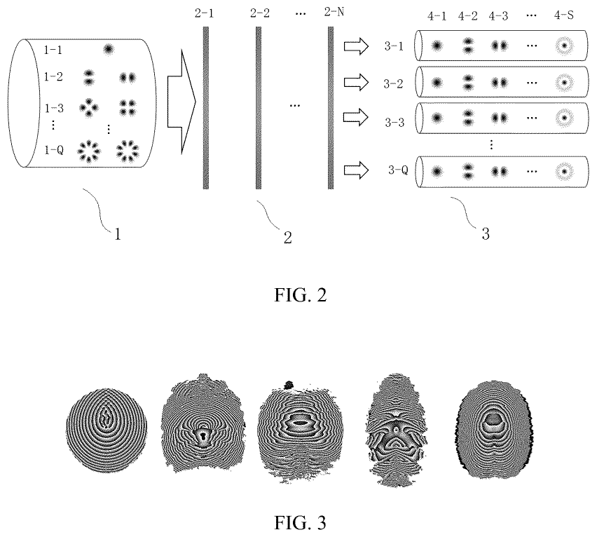

As shown in FIG. 2, the input weakly coupled fiber 1 uses a few-mode fiber, which includes Q mode groups to be demultiplexed, numbered 1-1 to 1-Q, where Q is set to 6. Each mode group includes one (zero-order mode group) or two (higher-order mode group) orbital angular momentum modes. The six mode groups include orbital angular momentum modes from −5 to +5 order.

As shown in FIG. 2, the output fiber array 3 uses a multi-mode fiber, including 6 channels, numbered 3-1 to 3-Q, corresponding to the 6 mode groups to be demultiplexed in the input weakly coupled fiber 1, to receive energy of a corresponding mode group. Each multi-mode fiber in the output fiber array 3 only uses first S mode bases, numbered 4-1 to 4-S, where S=6, and a plurality of fibers remain consistent. A larger Sis used to increase mode conversion efficiency, but a higher-order mode has a larger divergence angle, which also increases additional coupling loss.

The reflective cascaded diffractive network 2 includes N spatially separated phase plates, where N=5, numbered 2-1 to 2-N, with working space located between the input weakly coupled fiber 1 and the output fiber array 3. A function of the N spatially separated phase plates is to implement spatial separation of mode groups in the input weakly coupled fiber 1, ensuring that mode group energy can be maximally coupled to the corresponding fiber array 3.

In this embodiment, the fiber array 3 receives an output of the cascaded diffractive network 2 using any superposition of mode bases 4-1 to 4-S. Accordingly, a target output of the cascaded diffractive network 2 is not a deterministic mode, but any linear superposition of the mode bases 4-1 to 4-S.

Based on the above framework, further optimization design of the cascaded diffractive network 2 is performed to ensure proper conversion from the input weakly coupled fiber 1 to the fiber array 3. A process is as follows:

Step 1: Give a mode of the input weakly coupled fiber 1, and provide a cascaded diffraction output as follows according to Rayleigh-Sommerfeld diffraction:

$${E}_{N + 1 , m} = {E}_{0 , m} {F}_{1} {M}_{1} {F}_{2} {M}_{2} … {F}_{N} {M}_{N} {F}_{N + 1}$$

where N represents a quantity of phase plates; E_{0,m} represents an m-th input mode of the input weakly coupled fiber 1; E_{N+1,m} represents a corresponding final output mode field; Mk represents modulation of an optical field by a k-th phase plate Pₖ, k=1, 2, 3, . . . , N, which is a diagonal matrix with exp(jP,k) as diagonal elements; and Fₖ represents a transmission matrix corresponding to a k-th diffraction, which depends on a starting position of k-th diffraction space.

Step 2: Project the output mode field E_{N+1,m} onto a mode basis of a channel corresponding to a fiber array 3 after obtaining the output of the cascaded diffractive network 2, without comparing to a specific target mode field:

$${c}_{m , n , r} = 〈 {E}_{N + 1 , m} , {B}_{n , r} 〉 , r \leq S$$

where c_{m,n,r} represents a projection coefficient, B_{n,r} represents an r-th mode basis of an n-th receiving channel of the output fiber array 3; and S represents a quantity of mode bases supported by each fiber in the fiber array 3. Receiving fibers for different mode groups are different, and thus, corresponding mode bases are also different.

Step 3. Calculate energy from the output mode field coupled to each channel of the output fiber array 3, where coupling efficiency is a sum of corresponding mode basis components and can be described by the following transmission matrix T:

$${T}_{i , j} = {Σ}_{all m ∈ M {G}_{i}} ( {Σ}_{r = 1}^{S} {\vert {c}_{m , j , r} \vert}^{2} ) / \vert {MG}_{i} \vert$$

where MGᵢ represents a set of all modes in an i-th mode group of the input weakly coupled fiber 1, and |MGᵢ| is a quantity of modes included in the i-th mode group of the input weakly coupled fiber.

Step 4: To inversely optimize a phase Pₖ of each phase plate in the cascaded diffractive network 2, define a scalar evaluation function based on the transmission matrix T as follows:

$$L = 1 - a min \{ {T}_{i , i} \vert 1 \leq i \leq Q \} + b max \{ {T}_{i , j} \vert i \neq j , 1 \leq j , i \leq Q \}$$

where L reflects loss and crosstalk, a and b are used to control weight of the loss and crosstalk, respectively. In this embodiment, a=1, b=10; Q represents a quantity of channels in the fiber array 3; and L is determined by phase distribution of the phase plates and is a multivariate function with a phase plate parameter Pₖ as a variable.

Step 5: For ease of practical fabrication, replace a phase of the phase plate by distribution of an actual thickness Hₖ, where a reflective phase plate is used as an example, a relationship between the phase plate thickness Hₖ and the phase plate Pₖ satisfies Pₖ=4π Hₖ/λ, λ is an operating wavelength, and based on an error backpropagation method, a gradient of the phase plate thickness Hₖ is expressed as follows:

$$\frac{\partial L}{\partial {H}_{k}} = \frac{- λ}{2 π} Im \{ {Σ}_{m = 1}^{Q} diag [ {( {E}_{0 , m} {F}_{1} {M}_{1} L {F}_{k} {M}_{k} )}^{T} ( \frac{\partial L}{\partial {E}_{N + 1 , m}} {{F}_{N + 1}}^{T} {M}_{N} L {{F}_{k + 1}}^{T} ) ] \}$$

where Im represents getting an imaginary part of an operation result, and diag represents getting a diagonal element of the matrix.

Step 6: Indicate an optimization direction by the above gradient information, and combined with a gradient descent method, iteratively update a new set of phase plate parameters as follows:

$${H}_{k} \to {H}_{k} - α \partial L / \partial {H}_{k}$$

where α represents a learning rate, used to control a magnitude of parameter update. α can be set as a fixed value or adaptively determined by a specific algorithm during parameter iterative optimization.

Step 7: Calculate average loss ILₐᵥₑ and average crosstalk XTₐᵥₑ of a mode group demultiplexing device as follows:

$${IL}_{a v e} = 10 {log}_{10} ( \frac{1}{Q} {Σ}_{n = 1}^{Q} {T}_{n n} ) , X {T}_{a v e} = 10 {log}_{10} ( \frac{1}{Q} {Σ}_{n = 1}^{Q} \frac{1}{Q - 1} {Σ}_{m \neq n}^{Q} {T}_{m n} / {T}_{n n} )$$

When the designed loss and crosstalk meet a predetermined standard, the above parameter update process ends, and corresponding phase plate distribution is output.

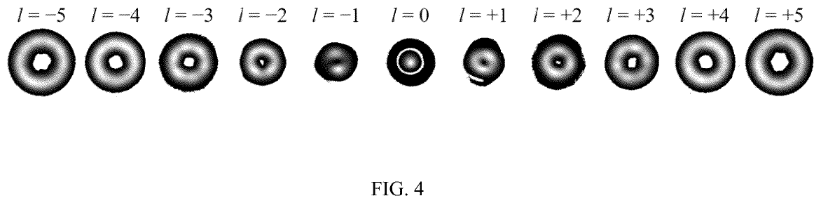

FIG. 3 shows design of a set of phase patterns for orbital angular momentum mode multiplexing, which includes N=5 phase blocks and can be used for demultiplexing 0-5 order orbital angular momentum mode groups.

In this embodiment, the designed phase plates determined in the above process can be processed into actual diffractive optical elements by photolithography. In this embodiment, three rounds of binary overlay lithography can be used. To this end, the phase plate distribution needs to be discretized into 8 steps, and then binarized as follows:

$${[ {b}_{2} {b}_{1} {b}_{0} ]}_{binary} = floor ( \frac{2 H}{λ} \times 8 )$$

where b₀, b₁, b₂ are V binary lithography masks, and etching depths corresponding to each binary mask are λ/2⁴, λ/2³, λ/2², respectively, to implement 2π phase modulation at wavelength λ.

A fabricated phase plate element can be plated with an enhanced reflection film. Combined with the few-mode fiber and the multi-mode fiber array, a mode group demultiplexing device is constructed.

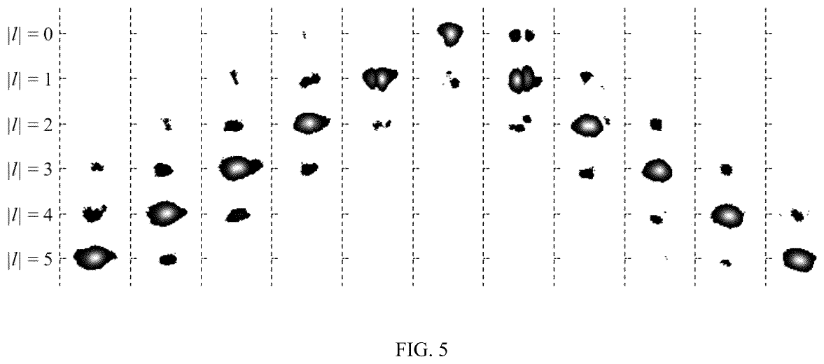

An orbital angular momentum input by the few-mode fiber includes 11 modes, with intensity distribution shown in FIG. 4. After passing through the cascaded diffractive network 2, a corresponding output optical field result of the orbital angular momentum mode is shown in FIG. 5. It can be learned that orbital angular momentum modes of different mode groups are output to different spatial positions, while orbital angular momentum modes belonging to the same mode group are output to the same spatial position after passing through the cascaded diffractive network 2, and can thus be received by the same multi-mode fiber.

In specific content of the above embodiments, technical features can be combined in any non-conflicting manner. For brevity, not all possible combinations of the above technical features are described. However, as long as there is no conflict in a combination of these technical features, the combination should be considered within the scope described in this specification.

Obviously, the above embodiments of the present invention are merely examples given to clearly illustrate the present invention, and are not intended to limit the implementation of the present invention. For those skilled in the art, other different forms of changes or modifications may be made based on the above description. It is neither necessary nor possible to exhaustively enumerate all embodiments herein. Any modifications, equivalent substitutions, and improvements made within the spirit and principle of the present invention should be included within the scope of protection defined by the claims of the present invention.

What is claimed is:

1. A mode group demultiplexing method based on a cascaded diffractive network, comprising following steps:
S1: initializing a phase plate parameter;
S2: selecting an input mode E_{0,m}: setting mode field distribution of the selected input mode as an input optical field based on an input weakly coupled fiber;
S3: calculating an output mode field of cascaded diffraction: calculating an output mode field E_{N+1,m} of the cascaded diffractive network based on the selected input mode E_{0,m};
S4: calculating a projection of the output mode field E_{N+1,m} onto a basis: projecting the output mode field E_{N+1,m} onto a mode basis of a corresponding channel in an output fiber array;
S5: calculating a mode group transmission matrix T_{i,j}: calculating energy of the output mode field coupled into each channel of the output fiber array, wherein coupling efficiency is a sum of corresponding mode basis components, and is represented by the transmission matrix T_{i,j}; and T_{i,j} represents a power when transmission is performed by an i-th mode group at an input end and receiving is performed by a j-th mode group channel at an output end;
S6: calculating a scalar evaluation function based on the transmission matrix T_{i,j};
S7: error gradient backpropagation: determining a gradient of a phase plate thickness Hₖ based on an error backpropagation method;
S8: gradient descent parameter correction: further iteratively updating a new set of phase plate parameters based on gradient information in step S7 and in combination with a gradient descent method; and
S9: calculating average loss and average crosstalk of a mode group demultiplexing device; and determining whether the loss and crosstalk meet a standard; and if yes, optimization ends; if not, returning to step S2.

2. The mode group demultiplexing method based on the cascaded diffractive network according to claim 1, wherein in step S3, the output mode field E_{N+1,m} of the cascaded diffractive network is calculated by following formula:
$${E}_{N + 1 , m} = {E}_{0 , m} {F}_{1} {M}_{1} {F}_{2} {M}_{2} … {F}_{N} {M}_{N} {F}_{N + 1}$$
wherein N represents a quantity of phase plates; E_{0,m} represents an m-th input mode of the input weakly coupled fiber; E_{N+1,m} represents a corresponding final output mode field; Mk represents modulation of the optical field by a k-th phase plate Pₖ and is a diagonal matrix with exp(jPₖ) as diagonal elements; and Fₖ represents a transmission matrix corresponding to k-th diffraction, wherein k=1,2,3, . . . , N, and m is a positive integer.

3. The mode group demultiplexing method based on the cascaded diffractive network according to claim 2, wherein in step S4, the projection of the output mode field E_{N+1,m} onto the basis is calculated by following formula:
$${c}_{m , n , r} = 〈 {E}_{N + 1 , m} , {B}_{n , r} 〉 , r \leq S$$
wherein c_{m,n,r} represents a projection coefficient, B_{n,r} represents an r-th mode basis of an n-th receiving channel in the output fiber array; and S represents a quantity of mode bases supported by each fiber in the output fiber array, and r is a positive integer.

4. The mode group demultiplexing method based on the cascaded diffractive network according to claim 3, wherein in step S5, the transmission matrix T_{i,j} is calculated by=following formula:
$${T}_{i , j} = {\sum }_{all m ∈ {MG}_{i}} ( {\sum }_{r = 1}^{S} {\vert {c}_{m , j , r} \vert}^{2} ) / \vert {MG}_{i} \vert$$
wherein MGᵢ represents a set of all modes in an i-th mode group of the input weakly coupled fiber, and |MGᵢ| is a quantity of modes comprised in the i-th mode group of the input weakly coupled fiber.

5. The mode group demultiplexing method based on the cascaded diffractive network according to claim 4, wherein in step S6, based on the transmission matrix T, the scalar evaluation function L is defined to reversely optimize each phase plate Pₖ in the cascaded diffractive network, with the scalar evaluation function L expressed as follows:
$$L = 1 - a min \{ {T}_{i , i} \vert 1 \leq i \leq Q \} + b max \{ {T}_{i , j} \vert i \neq j , 1 \leq j , i \leq Q \}$$
wherein L reflects the loss and crosstalk, a and b are used to control weight of the loss and crosstalk, respectively; and Q represents a quantity of channels in the output fiber array.

6. The mode group demultiplexing method based on the cascaded diffractive network according to claim 5, wherein in step S7, a relationship between the phase plate thickness Hₖ and the phase plate Pₖ satisfies Pₖ=4π Hₖ/λ, wherein λ is an operating wavelength, and a gradient of the phase plate thickness Hₖ is determined based on the error backpropagation method and is expressed as follows:
$$\frac{\partial L}{\partial {H}_{k}} = \frac{- λ}{2 π} Im \{ {\sum }_{m = 1}^{Q} diag [ {( {E}_{0 , m} {F}_{1} {M}_{1} L {F}_{k} {M}_{k} )}^{T} ( \frac{\partial L}{\partial {E}_{N + 1 , m}} {{F}_{N + 1}}^{T} {M}_{N} L {{F}_{k + 1}}^{T} ) ] \}$$
wherein Im represents an imaginary part of an operation result, and diag represents a diagonal element of the matrix.

7. The mode group demultiplexing method based on the cascaded diffractive network according to claim 6, wherein in step S8, the phase plate parameter is updated by following formula:
$${H}_{k} \to {H}_{k} - α \partial L / \partial {H}_{k}$$
wherein α represents a learning rate, used to control a magnitude of parameter update.

8. The mode group demultiplexing method based on the cascaded diffractive network according to claim 7, wherein in step S9, average loss ILₐᵥₑ and average crosstalk XTₐᵥₑ of the device are calculated by following formulas:
$${IL}_{a v e} = 10 {log}_{10} ( \frac{1}{Q} {\sum }_{n = 1}^{Q} {T}_{n n} ) , X {T}_{a v e} = 10 {log}_{10} ( \frac{1}{Q} {\sum }_{n = 1}^{Q} \frac{1}{Q - 1} {\sum }_{m \neq n}^{Q} {T}_{m n} / {T}_{n n} )$$
wherein Q represents a quantity of channels in the output fiber array.

9. The mode group demultiplexing method based on the cascaded diffractive network according to claim 8, wherein the phase plate is processed by binary lithography, phase plate distribution is discretized into 2V steps, and then binarized as follows:
$${[ {b}_{V} … {b}_{1} {b}_{0} ]}_{binary} = floor ( \frac{2 H}{λ} \times {2}^{V} )$$
wherein b₀, b₁, . . . , b_{V} are V binary lithography masks, and etch depths corresponding to each of the binary lithography mask are λ/2^{V+1}, λ/2^{V}, λ/2², respectively, to implement 2π phase modulation at wavelength λ.

10. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 1.

11. The mode group demultiplexing method based on the cascaded diffractive network according to claim 2, wherein in step S9, average loss ILₐᵥₑ and average crosstalk XTₐᵥₑ of the device are calculated by following formulas:
$${IL}_{a v e} = 10 {log}_{10} ( \frac{1}{Q} {\sum }_{n = 1}^{Q} {T}_{n n} ) , X {T}_{a v e} = 10 {log}_{10} ( \frac{1}{Q} {\sum }_{n = 1}^{Q} \frac{1}{Q - 1} {\sum }_{m \neq n}^{Q} {T}_{m n} / {T}_{n n} )$$
wherein Q represents a quantity of channels in the output fiber array.

12. The mode group demultiplexing method based on the cascaded diffractive network according to claim 3, wherein in step S9, average loss ILₐᵥₑ and average crosstalk XTₐᵥₑ of the device are calculated by following formulas:
$${IL}_{a v e} = 10 {log}_{10} ( \frac{1}{Q} {\sum }_{n = 1}^{Q} {T}_{n n} ) , X {T}_{a v e} = 10 {log}_{10} ( \frac{1}{Q} {\sum }_{n = 1}^{Q} \frac{1}{Q - 1} {\sum }_{m \neq n}^{Q} {T}_{m n} / {T}_{n n} )$$
wherein Q represents a quantity of channels in the output fiber array.

13. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 2.

14. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 3.

15. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 4.

16. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 5.

17. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 6.

18. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 7.

19. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 8.

20. A mode group demultiplexing device based on a cascaded diffractive network, comprising an input weakly coupled fiber, a cascaded diffractive network, and an output fiber array, wherein the input weakly coupled fiber comprises Q mode groups to be demultiplexed, and each mode group comprises several modes; the output fiber array comprises Q channels, and each fiber in the output fiber array supports S mode bases, with a quantity of the mode bases not less than a quantity of modes in a mode group of the input weakly coupled fiber; the cascaded diffractive network comprises several spatially separated phase plates, with working space for the several phase plates located between the input weakly coupled fiber and the output fiber array, used to implement spatial separation of mode groups in the input weakly coupled fiber, ensuring that mode group energy can be maximally coupled to a corresponding channel of the output fiber array; and each channel of the output fiber array is capable of receiving an output of the cascaded diffractive network in any one of corresponding mode bases or any linear superposition of corresponding mode bases, and a target output of the cascaded diffractive network is any linear superposition of S mode bases, wherein the cascaded diffractive network is optimally designed using the mode group demultiplexing method based on the cascaded diffractive network according to claim 9.
